(19) United States
(12) Patent Application Publication
(10) Pub. No.: US 2013/0285361 A1
(43) Pub. Date: Oct. 31, 2013

(54) Security Element and Method for Producing a Security Element

(71) Applicants: Rene Staub, Hagendorn (CH); Andreas Schilling, Hagendorn (ZG) (CH); Achim Hansen, Zug (CH)

(72) Inventors: Rene Staub, Hagendorn (CH); Andreas Schilling, Hagendorn (ZG) (CH); Achim Hansen, Zug (CH)

(73) Assignee: OVD KINEGRAM AG, Zug (CH)

(21) Appl. No.: 13/881,942

(22) PCT Filed: Oct. 31, 2011
(86) PCT No.: PCT/EP2011/005489

§ 371 Date: Jul. 3, 2013

(30) Foreign Application Priority Data
Nov. 2, 2010 (DE) 10 2010 050 031.3

(51) Int. Cl. B42D 15/00

(52) U.S. Cl. CPC B42D 15/00
USPC 283/85; 264/400

(57) ABSTRACT

A security element (1), in particular value document, and a process for producing same are described. The security element has a pattern area (21), consisting of one or more design elements (22), the shape of which provides a first optically perceptible item of information. It furthermore has a background area (20) surrounding the one or more design elements of the pattern area at least in areas. The security element (1) has an opaque reflective layer which is not provided in the background area (20), and in the pattern area (21) is provided in first zones (31), but not in second zones. The first zones (31) are spaced apart from each other by less than 300 μm and have a minimum dimension of less than 300 μm.

The invention relates to a security element, in particular a value document, as well as a process for producing a security element.

In the field of ID documents it is known to use transparent security elements which have an appearance that is optically variable in reflection, but still have sufficient transmissivity to also make visible or obtain information arranged beneath these security elements, for example individualized personal details about the owner of the ID document. Thus, for example U.S. Pat. No. 5,411,296 describes such a security element, which comprises a plastic film in which the surface relief of a hologram is moulded. This plastic film also has dot-shaped metal areas arranged in a regular pattern deposited over its whole surface. Beneath this security element, the substrate of an ID document, for example a passport, is then arranged to which for example the photograph of the passport holder as well as his personal details are applied. This individualized information is thus visible as a background behind the hologram arranged in the foreground.

The object of the invention now is to provide an improved security element as well as an improved process for producing a security element.

This object is achieved by a security element which has a pattern area, consisting of one or more design elements, the shape of which provides a first optically perceptible item of information, and a background area surrounding the one or more design elements of the pattern area at least in areas, wherein the security element has an opaque reflective layer which is not provided in the background area, and in the pattern area is provided in first zones, but not in one or more second zones or is provided in one or more second zones, but not in first zones, wherein the first zones are spaced apart from each other by less than 300 μm and have a minimum dimension of less than 300 μm. This object is further achieved by a process for producing a security element, in which a transparent transfer film is provided which has an area which is divided into a pattern area, the shape of which provides a first item of information, and a background area surrounding the pattern area at least in areas, in which there is moulded in the transfer film an opaque reflective layer which is not provided in the background area, and in the pattern area is provided in first zones, but not in one or more second zones or is provided in one or more second zones but not in first zones, wherein the first zones are spaced apart from each other by less than 300 μm and have a minimum dimension of less than 300 μm, and in which the transfer film is applied to a substrate such that a decoration layer, in particular a personalized decoration layer, which provides a second item of information is arranged between the transfer film and the substrate. This object is further achieved by a process for producing a security element in which a security element is provided which has a pattern area, consisting of one or more design elements, the shape of which provides a first optically perceptible item of information, and a background area surrounding the one or more design elements of the pattern area at least in areas, wherein the security element has an opaque reflective layer which is not provided in the background area, and in the pattern area is provided in first zones, but not in second zones, wherein the first zones are spaced apart from each other by less than 300 μm and have a minimum dimension of less than 300 μm, and in which an item of information, in particular personalized or individualized information, is inscribed by means of a laser into a laser-sensitive decoration layer arranged beneath the opaque reflective layer, wherein during the inscription the opaque reflective layer is arranged between the laser and the decoration layer.

It has surprisingly been shown that the brilliance of a reflective security feature provided in an intrinsically transparent area can be improved by the invention. If for example in the security element according to the invention the first zones are thus additionally superimposed with a relief structure generating an optically variable effect and a decoration layer with a second item of information is provided beneath the opaque metallic layer, then the brilliance of both the first and the second items of information is surprisingly increased for a human observer compared with the solutions known in the state of the art.

In general it is usually assumed that at a viewing distance which corresponds approximately to the standard reading distance, i.e. approx. 20-40 cm, the resolution limit of the naked human eye is approximately 300 μm, i.e. objects which are smaller than approximately 300 μm can no longer be reliably resolved, i.e. can no longer be perceived as individual objects.

Thus, the invention makes it possible to cover sensitive areas in a personalized or individualized document, such as for example a photograph or a validity date or a serial number, with a security feature based on an opaque reflective layer, without significantly impairing the recognizability of this area and this information. The personalized or individualized information can thus be recognized satisfactorily even under poor ambient light visibility conditions and the security feature allows the authenticity and integrity of the document to be verified.

It is of further advantage that due to the fine structuring of the reflective layer in the register mark, i.e. in a registration-accurate, i.e. positionally accurate, arrangement relative to the design elements no impairment or design limitation of the diffractive feature occurs, irrespective of a reduction in brightness. Furthermore, the sub-structuring of the reflective layer in the design elements is preferably adapted to the sizes and shapes of the design elements in order to avoid problems which would occur for example with a regular grid in a reflective layer. Thus, studies have shown that with a regular grid in the reflective layer in particular fine lines can be represented only inadequately.

If, as described above, the information, in particular a personalized or individualized item of information, is inscribed by means of a laser in a laser-sensitive decoration layer arranged below or above the opaque reflective layer, then the following process is preferably used for this: the laser is controlled such that the areas with opaque reflective layer are omitted when the information is inscribed or at least are impacted with reduced power. For this, firstly, it can be determined, for example by means of a corresponding optical sensor, whether the area which is to be processed with the laser has an opaque reflective layer or not. Furthermore, it is also possible to ascertain this information from a previously saved data set which contains the design of the opaque reflective layer. In the areas in which the information is to be inscribed, but an area with opaque reflective layer is provided, either the power of the laser is reduced or the inscription of the information in this area by means of the laser is omitted.

According to a preferred embodiment example of the invention, the security element has a replication layer in which in the first zones at least in areas an optically active surface relief, in particular for generating an optically variable effect, is moulded. This surface relief preferably has one or more relief structures selected from the group: diffractive grating, hologram, blazed grating, linear grating, cross grating, hexagonal grating, asymmetrical or symmetrical grating structure, retroreflective structure, refractive or diffractive microlens, refractive or diffractive microprism, zero-order diffraction structure, moth-eye structure or anisotropic or isotropic matte structure.

Furthermore, it is advantageous to locally vary the parameters of the relief structure, for example the orientation of grating grooves, the profile shape or the structure depth or several of these parameters combined.

Grating structures can also be curved or have a stochastic variation of at least one grating parameter, such as for example spacing, structure depth or profile shape.

The surface relief can also consist of a regular, partially regular or random arrangement of peaks and valleys. In addition, the surface relief can have a stepped profile shape and these steps can have in particular a uniform height. Furthermore, this surface relief can comprise an additive or subtractive superimposition of two or more of the above-named relief structures. By a diffractive grating is meant a relief structure with a spatial frequency of from 100 to 5000 lines/mm, the structural elements of which preferably have a structure depth of between 0.1 and 20 μm, in particular between 0.1 and 10 μm. Relief structures with triangular structural elements which are arranged spaced apart from each other by between 0.2 and 10 μm are preferably used as blazed gratings. Cylindrical lenses or spherical lenses with a focal length of from 5 to 500 μm and/or a structure depth of from 0.1 to 50 μm are preferably used as microlenses.

Microprisms which have a structure depth of from 0.1 to 25 μm, a structure width at the base of from 5 to 300 μm and are spaced apart from each other by preferably between and 300 μm are preferably used as microprisms.

Matte structures with a correlation length of between 0.2 and 20 μm are preferably used as matte structures. Regular structures with a spatial frequency of more than 2000 lines/mm are preferably used as zero-order diffraction structures.

The surface relief here preferably has different areas which are overlaid with different ones of the relief structures identified above. By different relief structures are meant, firstly, relief structures which differ in the shape of the structural elements, and/or in their arrangement relative to each other in one or more structure parameters, for example have a different spatial frequency and/or a different azimuthal angle. The areas can have boundaries with adjacent areas at which the above-named properties of the relief structures change abruptly. Furthermore, continuous local transitions of the parameters of the relief structures are also possible. Furthermore, quasi-continuous local transitions of the parameters of the relief structures are also possible, e.g. a local interlacing, i.e. concertinaing or alternating arrangement of partial sections of the respectively adjoining relief structures in a transition area.

It is furthermore of particular advantage if the surface relief is provided registered, i.e. positionally accurate, relative to the first zones. Thus, it is particularly advantageous if no surface relief is moulded into the replication lacquer layer in the second zones and/or in the background area or a surface relief which differs from the surface relief moulded in the first zones is moulded there. Thus, for example, the surface relief in the second zones and/or in the background area is determined only by the production-related surface roughness of the replication lacquer layer and thus for example has a structure depth or roughness depth there of less than 100 nm, or has a relief structure there that differs from the relief structure in the first zones, in particular a relief structure the aspect ratio of which differs from that of the surface relief moulded in the first zones by at least 25%, in particular by at least 50%. By aspect ratio is meant here the ratio of relief depth to width of the structural elements of the relief structure. It has been shown that the brilliance and also the protection against forgery of the security element can be significantly increased by such a design of the surface relief moulded into the replication lacquer layers. Thus, for example, a registration-accurate, i.e. positionally accurate, alignment of the surface relief relative to the first zones can only be achieved by means of substantial technological outlay, and attempts at forgery or manipulation are immediately recognizable, as for example in the course of detaching or manipulating one of the layers the optically variable information is immediately altered because of the resultant register deviations, i.e. deviations from the positional accuracy of the alignment of the surface relief relative to the first zones, and thus forgeries can be identified clearly.

The surface relief here is preferably moulded in the surface of the replication layer facing the opaque reflective layer and in particular moulded into the boundary surface between replication layer and opaque reflective layer.

According to a preferred embodiment example of the invention, in a plurality of first zones in each case a microlens or a microprism is moulded into the replication lacquer layer as surface relief. The surface moulding and surface dimensioning of the respective first zones on which the microlens or the microprism is placed are chosen here in particular such that the respective microlens or the respective microprism occupies the whole surface of the respective first zone. The structuring of the opaque reflective layer in the pattern area is thus precisely registered, i.e. positionally accurate, relative to the individual lenses, with the result that each lens has the reflective layer all over, but the background has no reflective layer at all and is transparent or translucent or diaphanous. The brilliance of the security features of the security element as well as its protection against forgery is hereby further improved.

According to a further preferred embodiment example of the invention, the proportion of the surface covered by the respective first zones which is overlaid with the surface relief is varied locally in the pattern area. This makes it possible to vary the brightness with which the pattern area appears in various viewing directions and thus to increase the optical complexity of the security feature provided by the security element. Furthermore, it is particularly advantageous here to keep the area size of this first zone constant. This furthermore achieves the advantage that the visual appearance of the second item of optical information possibly provided beneath the opaque optical reflective layer is, however, not influenced and thus these changes in brightness appear particularly eye-catching.

According to a further preferred embodiment example of the invention, first zones, preferably each of the first zones of a design element or of the pattern area, are divided into n part-zones in which different relief structures are moulded into the replication layer as surface relief, wherein n≧2. Thus, for example, a diffractive grating is moulded in a first part-zone, a matte structure is moulded in a second part-zone and a mirror surface is moulded in a third part-zone as relief structure. This makes it possible to provide in the pattern area an optical security feature that can only be copied with difficulty. Thus, it is possible for example to generate optically variable effects in the pattern area which cannot be realized by a hologram and which thus cannot be realized for example in the case of an unregistered, i.e. not positionally accurate, arrangement of first zones relative to a relief structure.

Furthermore, it is advantageous if in each case one of the part-zones of each of these first zones is allocated to a viewing direction. Thus, for example, m viewing directions are provided and each of these first zones has n≧m part-zones which are allocated in each case to one of the m viewing directions. The part-zones of the first zones that are allocated to one viewing direction are preferably overlaid with the same relief structure. Furthermore, it is advantageous if the area size of the respective part-zones is varied locally to determine the local brightness in the viewing direction allocated to the respective part-zone. In addition or alternatively to this, it is also possible for part-zones of the first zones to be allocated in each case to one of k colour components. Thus, for example, it is possible for three colour components (R G B, meaning e.g. red, green, blue) to be provided and for first zones to have in each case three part-zones, of which respectively a first is allocated to the colour component R, a second to the colour component G and a third to the colour component B. Here too, it is advantageous if the part-zones allocated to one and the same colour component have the same relief structure. Furthermore, it is also possible here for the area size of the respective part-zones to be locally varied to determine the local brightness and the colour value. This makes it possible to generate, in a transparent area, true-colour images visible in reflection and/or images varying in their brightness and/or colour value in different directions as a security feature. Even if k=2, images which produce a true-colour impression can be represented. Although the colour space is limited, it is still sufficient for many applications. The advantage is in particular that only 2 part-zones are needed. On the other hand, if k≧2, in particular k≧3, the representable colour space can be enlarged, while, disadvantageously, more part-zones are needed.

Furthermore, it is advantageous if first zones have a part-zone in which no relief structure is moulded into the replication layer. Thus, it is possible for example for the first item of optical information to have a brightness locally different in reflection, which is determined by the respective local area size of the first zone and is superimposed with an optically variable item of information which is determined by the type of and proportion of the surface covered by the relief structures of the surface relief moulded in the respectively first zones. In addition, different items of information are also generated hereby in transmission and in reflection by the security element.

According to a further preferred embodiment example of the invention, the width, length and/or the spacing of the first zones are varied in a Moiré area to generate a concealed item of Moiré information which is visible as a third item of information in the Moiré area when superimposed with an allocated Moiré verification element.

Thus, the Moiré area is for example divided into a Moiré background area and a Moiré pattern area.

For example, the width, length and/or spacing of the first zones in the Moiré background area and the Moiré pattern area have slightly different parameter values (which are chosen in the range of the grid widths of the structural elements of the Moiré verification element), with the result that when superimposed with the Moiré verification element the Moiré pattern area becomes visible against the Moiré background area. Printed, metallized or otherwise structured one-dimensional or two-dimensional grids can act as verification element, in particular one-dimensional or two-dimensional microlens grids or line grids. The differences in the parameter values (width, length and/or spacing) for Moiré pattern area and Moiré background area and the corresponding parameter values of the Moiré verification element typically differ in the range of from 0.1% to 10%.

According to a further preferred embodiment example of the invention, a sub-structuring of the optically active surface relief is provided inside the optically active surface relief of the first zones to generate a concealed item of Moiré information, wherein the concealed item of Moiré information becomes visible as a third item of information when superimposed with an allocated Moiré verification element. Thus, for example, the relief shape and/or the structure depth and/or the azimuthal angle and/or the spatial frequency of the optically active surface relief in the Moiré background area and in the Moiré pattern area of the concealed item of Moiré information are chosen slightly different as parameters, and also chosen slightly different to the corresponding parameters of the Moiré verification element, with the result that the Moiré pattern area becomes visible against the Moiré background area when superimposed with the Moiré verification element.

Printed, metallized or otherwise structured one-dimensional or two-dimensional grids can act as Moiré verification element, in particular one-dimensional or two-dimensional microlens grids or line grids. The differences in the parameter values (width, length and/or spacing) for Moiré pattern area and Moiré background area and the corresponding parameter values of the Moiré verification element typically differ in the range of from 0.1% to 10%. For example, the Moiré pattern area and/or the Moiré background area can be designed in the form of one-dimensionally compressed design elements which are Moiré-magnified by the Moiré verification element and display dynamic effects when the Moiré verification element is moved.

Animated, in particular one-dimensional or two-dimensional, Moiré effects which become visible when the security element is tilted and/or when the Moiré verification element is moved relative to the pattern area of the concealed item of Moiré information are particularly interesting here.

According to a preferred embodiment example of the invention, the first zones in the pattern area are arranged according to a one- or two-dimensional grid, wherein the grid width is in particular between 5 and 1000 μm, further preferably between 20 and 500 μm, still further preferably between 25 and 250 μm. The grid here can be a periodical grid. However, it is also possible for it to be an irregular or also a stochastic grid which is adapted in particular to the shape of the design elements.

Furthermore, it is particularly advantageous if the proportion of the surface of the pattern area covered by the first zones is between 1 and 80%, in particular between 2 and 50%.

Furthermore, it is preferred if the spaces between the first zones are between 25 and 250 μm and/or if the width and/or length of the first zones is chosen in the range of from 5 to 100 μm.

The first zones are expediently formed as polygons, in particular rectangular or as trapeziums, wherein the corners can also be rounded, or elliptical, in particular circular. Furthermore, the first zones can also have simple figurative shapes or motifs, such as for example a letter, a symbol or a logo.

According to a preferred embodiment example of the invention, the pattern area comprises one or more design elements which are each shaped in the form of a line, the width of which is in particular at least 10 times greater than the length. The pattern area thus comprises a pattern composed of one or more lines. One or more of these lines are preferably shaped in the form of a guilloche.

The width of the lines here is preferably between 5 and 250 μm, further preferably between 10 and 100 μm.

According to a preferred embodiment example of the invention, the first zones of such a design element are arranged according to a one-dimensional grid along the longitudinal direction of the respective line, with the result that in each case only one first zone is provided over the width of the line. It is thus possible for each of the first zones to occupy the whole width of the line and for the width of the first zone to correspond to the width of the line. However, it is also possible for the extent of the first zone to vary in the direction of the width of the line, wherein in particular the extent of the first zone in the longitudinal direction of the line and/or the spacing of the first zones is constant. It has been shown that the contour sharpness of the first item of information can be increased by such a design of the first zones.

Furthermore, it is advantageous if the area size of the first zones varies along the respective line in order to produce locally different brightness intensities in reflection. This is preferably realized as set out above. Furthermore, it is also possible for the spaces between the first zones to vary along the line in order to thus produce locally different brightness intensities in reflection.

In addition, it is advantageous if the shape and size of the first zones are adapted to the dimensions of the design elements of the surface relief moulded into the reflective layer, as already set out above. It is further advantageous here if different relief structures are moulded as surface relief in first zones allocated to different lines. In addition, it is also possible—as already set out above—for the first zones allocated to a line to be divided into n part-zones, wherein here too the division into part-zones, the number of part-zones and the relief structures moulded into the part-zones are preferably different from line to line.

According to a further preferred embodiment example of the invention, the pattern area comprises one or more design elements, in the area of which one or more first zones are shaped as lines which follow the external and/or internal contour of the design element. The width of these lines is preferably between 20 and 300 μm. Furthermore, it is also preferred that several first zones are shaped as parallel lines which follow the external and/or internal contour of the design element. Furthermore, it is also possible for these lines to be interrupted in areas.

A reflective layer of metal is preferably used as opaque reflective layer. The layer thickness of the reflective layer is chosen here such that less than 30% of the light visible for humans is transmitted through this layer. Furthermore, it is also possible to use one or more transparent reflective layers, for example HRI or LRI layers (HRI=High Refraction Index; LRI=Low Refraction Index) and to combine these transparent or translucent reflective layers with an opaque layer lying beneath them, for example to underlay them with an opaque lacquer layer.

Furthermore is it advantageous if the opaque reflective layer consists of an electrically conductive material or comprises such a material and furthermore provides a fourth, electrically readable item of information through the formation of the first zones as RF elements (RF=Radio Frequency) or through the influencing of the surface conductivity of the first zones, for example by corresponding spacing of the first zones.

Furthermore, it is advantageous to also reinforce the opaque reflective layer galvanically, if it consists of an electrically conductive material, and thus in particular to apply a galvanic reinforcement layer thickness of between 0.2 and 20 μm. It has been shown that the properties of the security element in respect of a laser personalization, in particular a subsequent laser personalization, can hereby be improved. If a laser-sensitive layer which is irradiated with a laser during the personalization or individualization of the security element to inscribe information is thus provided for example beneath the opaque reflective layer, destruction of the opaque reflective layer is prevented by this layer and the visual appearance of the security features of the security element is improved.

As already stated above, the security element preferably has a decoration layer for generating a second optically perceptible item of information which is arranged beneath the opaque reflective layer relative to the viewing direction of the security element. When the security element is viewed, the first and the second optically perceptible items of information are superimposed, with the result that the second optically perceptible item of information is protected against forgery and manipulation. The second optically perceptible item of information here is preferably a personalized or individualized item of information, for example personal data of the holder of an ID document, such as for example passport number, serial number, name, photograph of the passport holder etc. Preferably, the second optically perceptible item of information, which is provided for example by corresponding shaping or irradiation of the decoration layer, is shaped and/or arranged such that it is superimposed on both the pattern area and the background area at least in areas in each case.

Furthermore, it is advantageous that all layers of the security element arranged above the opaque reflective layer relative to the viewing direction of the security element are transparent, or translucent, at least in areas and/or that all layers of the security element arranged between the opaque reflective layer and the decoration layer are transparent or translucent at least in areas. However, these layers can also be diaphanously dyed, partially transparent, partially translucent or partially dispersive. The properties can also vary locally in respect of the transparency.

Furthermore, it is also possible for the security element to be formed as a security element acting both in transmission and in reflection and thus for all layers of the security element arranged beneath the opaque reflective layer relative to the viewing direction of the security element to be transparent or translucent.

The security element can firstly be formed as a transfer film or laminating film which has the opaque reflective layer. It is also possible for the security element to be formed by a value document, for example by a banknote, an ID document, a credit card etc. or by a label for product assurance which preferably also comprises many further layers in addition to the opaque reflective layer.

The invention is explained by way of example below with reference to several embodiment examples with the aid of the attached drawings.

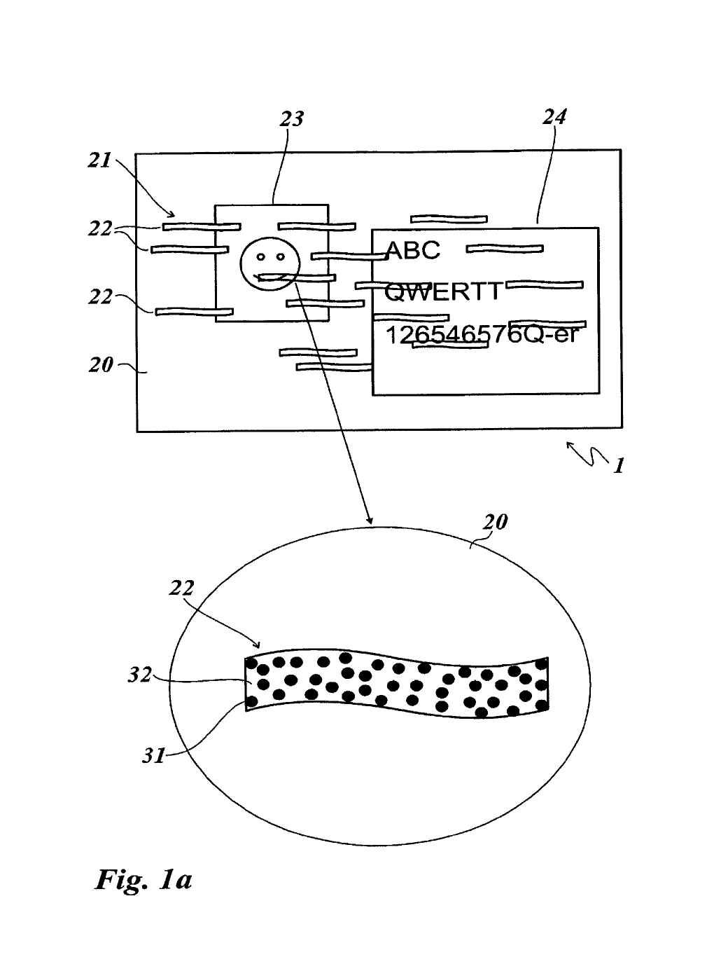

FIG. 1a shows a schematic representation of a top view of a security element with an enlarged cut section.

FIG. 1b shows a schematic representation of an enlarged cut section of the security element according to FIG. 1a.

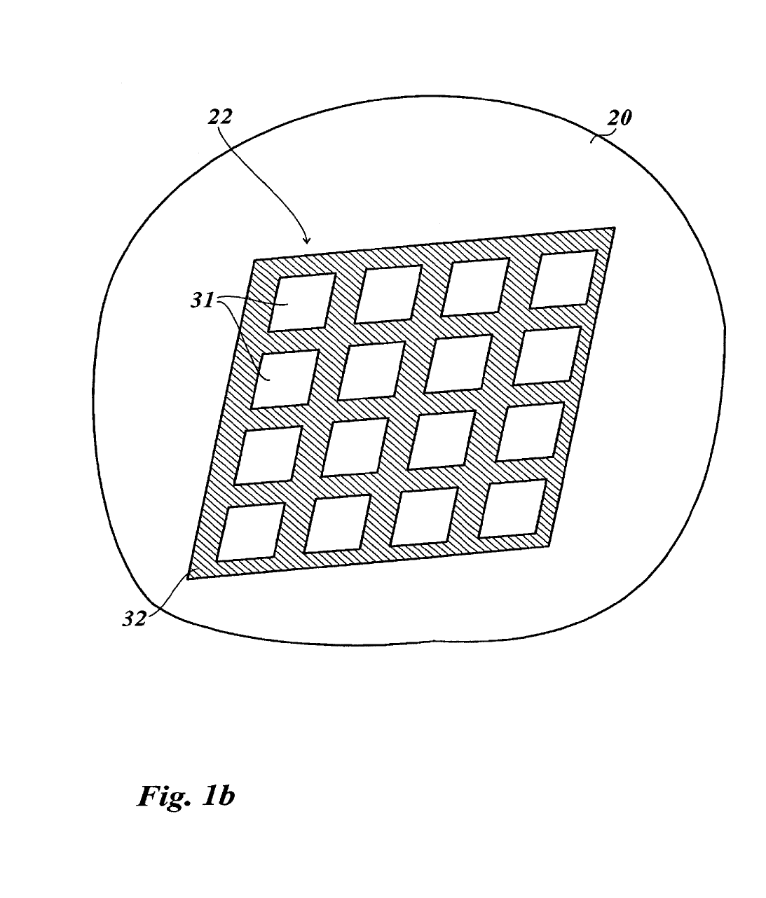

FIG. 2 shows a schematic sectional representation of a cut section of a security element.

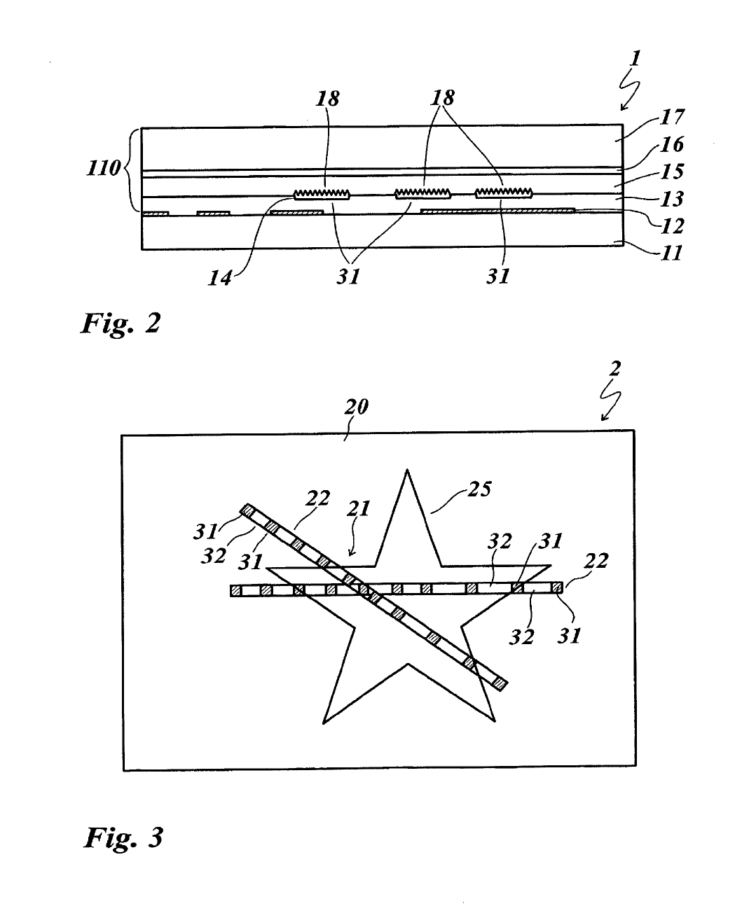

FIG. 3 shows a schematic top view of a security element.

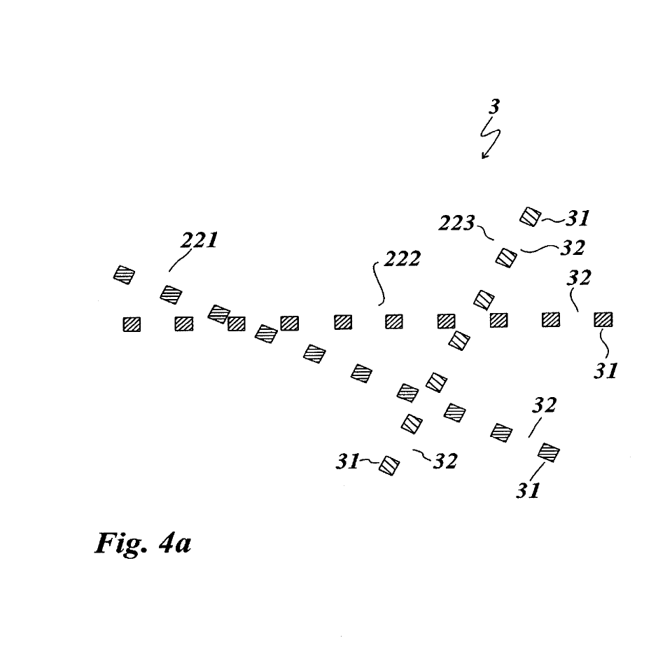

FIGS. 4a to 4c each show a schematic top view of a partial section of a reflective layer of a security element.

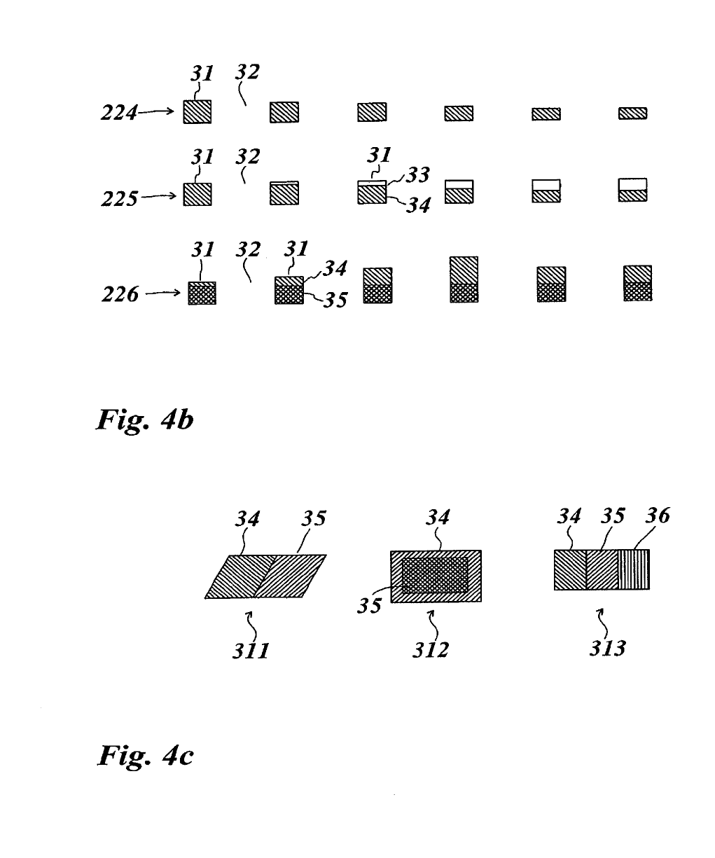

FIG. 5a shows a schematic top view of a partial section of a replication layer of a security element.

FIG. 5b shows a schematic top view of a partial section of a reflective layer of a security element.

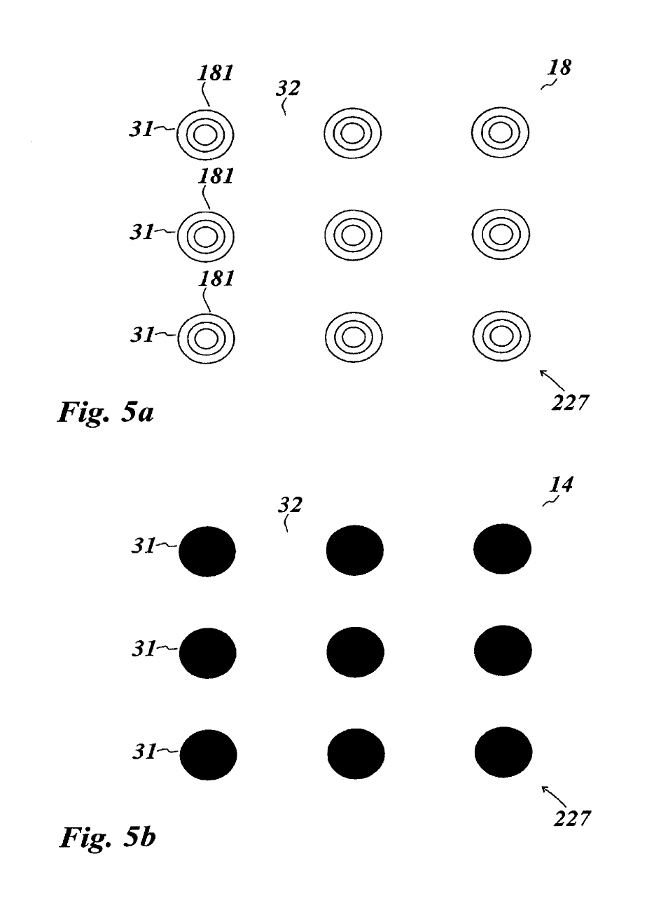

FIG. 6a shows a schematic top view of a partial section of a replication layer of a security element.

FIG. 6b shows a schematic top view of a partial section of a reflective layer of a security element.

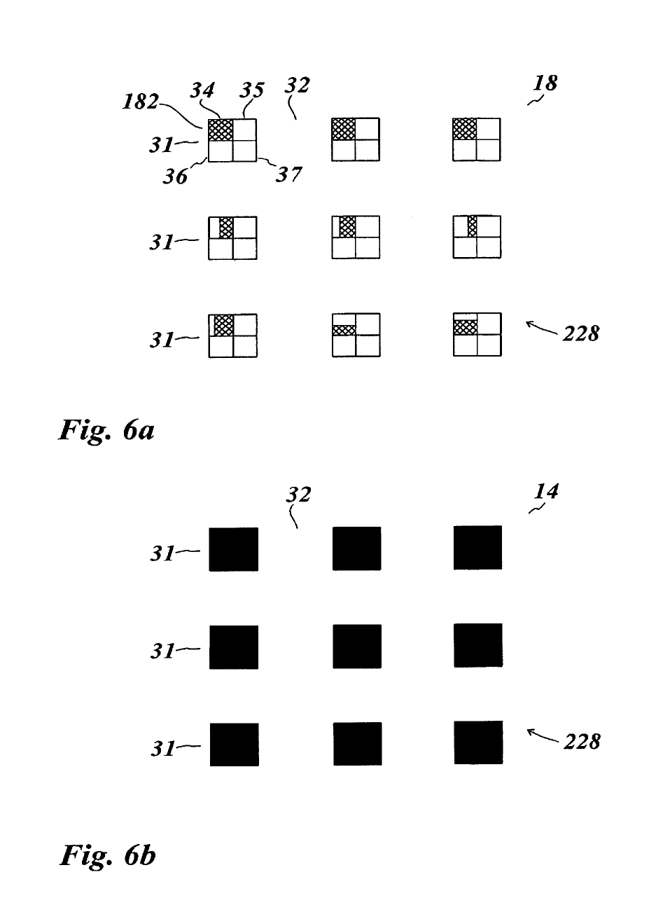

FIG. 7 shows a schematic top view of a partial section of a security element.

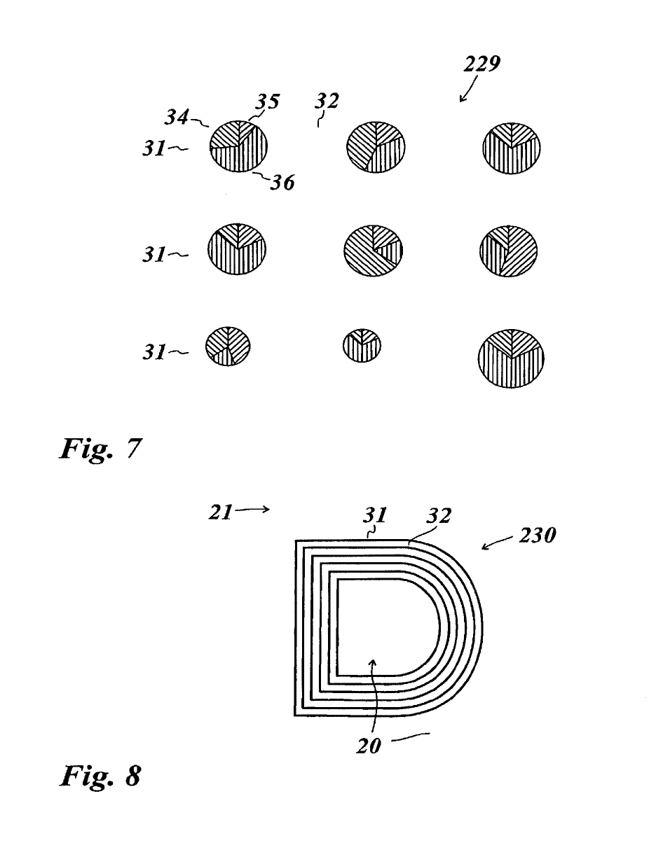

FIG. 8 shows a schematic top view of a partial section of a reflective layer of a security element.

FIG. 1a shows a security element 1 the layer structure of which is represented by way of example in FIG. 2.

The security element 1 has a substrate layer 11, a decoration layer 12, an optional adhesive layer 13, a reflective layer 14, an optional replication layer 15, an optional layer 16 and an optional layer 17. In addition to these layers, the security element 1 can also comprise further layers.

The security element 1 is preferably formed by a security document, in particular by an ID document, for example a passport, a driving license or an access card. However, it is also possible for the security element 1 to be a value document, for example a banknote, credit card or the like.

Furthermore, it is also possible for the security element to be formed by a multi-layered body, in particular in the form of a transfer film or laminating film, which comprises the reflective layer 14 and in particular does not comprise the decoration layer 12 and the substrate layer 11. Thus, the security element 1 can for example be formed as a transfer film which comprises the layers 17, 16, 15 as well as optionally the adhesive layer 13. Furthermore, the security element 1 can also be formed by a laminating film which comprises the layer 17, the replication layer 15 and the reflective layer 14. Furthermore, the security element 1 can also be formed by a laminating film which has the replication layer 15, which additionally acts as carrier layer, as well as the reflective layer 14 and the optional adhesive layer 13. Such a multi-layered body is intended in particular to be applied to one or more layers of an ID document or value document as a security element, or to be embedded between layers of an ID document or value document. The following description of the layers 13, 14, 15, 16 and 17 furthermore relates to such a design of the security element 1.

The substrate layer 11 can consist for example of a paper substrate or a plastic substrate or a sequence of several paper and/or plastic layers in particular bonded to a laminate or extrudate. The substrate layer 11 preferably has a layer thickness of between 25 and 2000 μm, further preferably between 40 and 1000 μm.

The decoration layer 12 preferably consists of one or more preferably dyed lacquer layers.

The colouring of the decoration layer 12, or of the lacquer layers forming this, can be carried out for example using dissolved dyes or also by means of pigments or combinations of dyes and pigments. In particular, these can be dyes or pigments that are UV fluorescent or can be excited by IR radiation. The colouring of the decoration layer 12 can also be carried out using optically variable dyes or pigments, so-called OVI® (OVI=Optically Variable Ink), i.e. using dyes and/or pigments having different visual appearances depending on the viewing situation, e.g. depending on the angle of view and/or of illumination.

These lacquer layers are formed to provide an optically perceptible item of information and thus provide for example the items of optical information 23 and 24 represented schematically in FIG. 1a. Thus, the decoration layer 12 is formed for example in one area of the security element 1 in the form of an image of the holder of the security element 1 as item of optical information 23 and in another area of the security element 1 in the form of text giving details of the holder of the security element 1, for example comprising the name of the holder, his address and/or his ID number. Furthermore, the decoration layer can also have non-personalized or non-individualized information, such as for example one or more security prints. The lacquer layers of the decoration layer 12 preferably consist of one or more lacquer layers coloured differently relative to the substrate layer 11 and can, in addition to dyes or “normal” colour pigments, also comprise effect pigments, such as for example thin-film layer pigments, liquid crystal pigments or metal pigments or effect pigments aligned by magnetic fields. If colour pigments are used in the decoration layer 12, it is thus also possible for the items of information 23 and 24 to have an optically variable appearance, for example display a colour change effect. The security print can have optically variable constituents and optically invariable constituents. The security print can in addition also have other, in particular non-optical, security features.

Furthermore, it is also possible for the decoration layer 12 to consist of a laser-sensitive material or to comprise one or more layers of a laser-sensitive material in which for example the items of optical information 23 and/or 24 are inscribed by means of a laser. By laser-sensitive material is meant here a material which is excited to change colour by the action of a laser or is hereby removed at least partially and/or in areas.

The decoration layer 12 and the substrate layer 11 can also be dispensed with. Furthermore, it is also possible for yet further or other layers than the adhesive layer 13 to be arranged between the reflective layer 14 and the decoration layer 12 or for the reflective layer 14 to follow the decoration layer 12 directly.

The layers 13 to 17 can be formed for example by a transfer film 110 or by the transfer layer of a transfer film. In this case, the layer 16 is formed by a detachment layer and the layer 17 is formed by a carrier layer. The layers 13 to 15 then form the transfer layer, which remains on the carrier substrate 11 after removing the carrier layer 17 and the detachment layer 16. Additional layers, not shown in FIG. 2, can be transferred, such as for example one or more protective layers which increase the resistance to wear or chemical action. The adhesive layer 13 can also consist of several layers, such as for example a primer and one or more layers of different adhesive layers. Further additionally transferred layers can be interlayer adhesion promoter layers or barrier layers. The carrier layer 17 in this case preferably consists of a plastic film, for example a polyester film, with a layer thickness of between 6 and 200 μm. The plastic film can also consist for example of PET (polyethylene terephthalate), PEN (polyethylene naphthalate) or BOPP (biaxially oriented polypropylene).

In addition, it is also possible for the layers 13 to 17 to form a laminating film. In this case, the layer 16 is formed by an adhesion promoter layer and the layer 17 is formed by a plastic film which can also function as a protective layer or cover layer of the security element 1. In this case, the layer 17 is preferably likewise formed by a transparent plastic film with a layer thickness of between 6 and 200 μm, preferably of polyester, PET, BOPP or of polycarbonate (PC). In addition to or instead of the layers 16 and 17, the security element 1 can also comprise one or more further, preferably transparent layers which also provide for example the function of a cover layer for protection against mechanical and/or chemical actions in the case of a card-shaped formation of the security element. The adhesive layer 13 preferably consists of a hot-melt adhesive, in particular a heat-activatable thermoplastic adhesive, with a layer thickness of between 0.2 and 30 μm. The replication layer 15 preferably consists of a thermoplastic replication lacquer with a layer thickness of between 0.2 and 10 μm. A surface relief 18 is moulded into the replication layer 15 by means of a stamping tool using heat and pressure. Furthermore, it is also possible for the replication layer 15 to consist of a UV curable material and for the surface relief 18 to be moulded into the replication layer 15 by UV replication.

Instead of several layers 15, 16, 17, only one individual layer which assumes several functions can also be present. Thus, for example, replication can be carried out directly into a polymer film, and this film can then be bonded, with or without the help of an adhesive layer, to a security element. Suitable materials are for example PC or PET. Typical layer thicknesses of the polymer film lie in the range 8 to 500 μm, preferably in the range 12 to 250 μm, still more preferably in the range 20 to 150 μm.

The reflective layer 14 preferably consists of an opaque metal layer, for example of aluminium, copper, silver, gold, chromium or an alloy of these metals. By opaque is meant here a reflective layer the transmission of which in the area of the wavelength range of the light visible for the human observer is less than 30%, preferably less than 10%. If the reflective layer 14 is formed by a metal layer, the layer thickness of this metal layer is chosen accordingly, in order that the metal layer forms an opaque reflective layer according to this definition. Such a metallic reflective layer preferably has a layer thickness greater than 10 nm, in particular greater than 15 nm.

Furthermore, it is also possible for the reflective layer 14 to consist of several layers. Thus, it is possible for example for the reflective layer 14 to consist of one or more dielectric reflective layers, for example of a sequence of high and low refractive index layers (HRI or LRI layers) or of a high or a low refractive index layer which is furthermore underlaid with an opaque layer for forming an opaque reflective layer.

Furthermore, it is also possible for an additional dielectric reflective layer which is provided in particular over the whole surface, only in the pattern area, only in the background area or only in the areas in which the reflective layer 14 is not provided to be provided below or above the reflective layer 14.

For example layers of ZnS, TiO₂, SiOx or MgF₂ which preferably have a layer thickness of between 25 and 2500 nm can be used here as dielectric reflective layers.

Furthermore, semi-conductive layers are also possible, such as for example Si, Ge, PbS, ZnSe, GaAs.

Metallically acting reflective layers can also be applied by a printing process, for example as nanoparticles finely dispersed in a printing lacquer or thin metallic flakes. Furthermore, the reflective layer can also be formed as a photonic crystal.

An opaque lacquer layer which has a transmissivity of less than 30% in the wavelength range of the light visible for the human observer is preferably used as opaque layer. This lacquer layer is preferably applied by means of a printing process. Furthermore, the lacquer layer can be dyed and for example produce a colour impression in reflection.

Furthermore, the reflective layer can also consist of a dielectric layer or a sequence of several dielectric layers which are covered by a metallic layer. By suitable choice of the layers and their thicknesses, particularly interesting colour effects can be achieved, if the dielectric layers are formed transparent or translucent.

As shown in FIG. 1a, the security element 1 has a pattern area 21 consisting of several design elements 22 and a background area 20 surrounding the design elements 22. The design elements 22 of the pattern area here can also have an identical shape and form a repetitive (a repeating) pattern. Furthermore, it is also possible for the design elements to form supplementary motifs, for example a figurative representation, or to be formed for example in the form of numbers, symbols or letters to generate an optically perceptible item of information. Furthermore, it is particularly preferable that the design elements are formed as lines which form for example a guilloche or a complex line pattern, such as will be explained in even more detail below.

The pattern area 21 is preferably shaped in the form of a macroscopically visible design, i.e. the shape of the pattern area 21 specified by the design elements 22 is visible to the human observer from a viewing distance of approximately 30 cm. The design elements 22 of the pattern area 21 thus preferably have, at every point, a length of more than 50 μm, preferably of 300 μm and a width of more than 5 μm, preferably of more than 10 μm. The background area 20 here is dimensioned at least large enough for the pattern area 21—as set out above—to be recognizable in front of the background area 20. The background area 20 thus firstly surrounds the design elements 22, formed in each case from a continuous area, preferably completely and has a width and/or length of more than 1 mm, preferably of more than 2 mm. The design elements 22 can also be bordered by the edge of the security element 1 and need not be completely surrounded by the background area.

In addition, there can be further design elements which have a reflective layer over the whole surface or have zones which have a minimum dimension greater than 300 μm.

The background area 20 can also be formed by one or more further layers forming additional security features which were preferably applied to the substrate layer 11 in a separate production step. These further layers can be individualized or personalized and/or have a conventional hologram, Kinegram®, which has diffractive structures with one or more reflective layers over the whole surface or over part of the surface, and/or a volume hologram and/or a three- or multi-layered thin film structure (Fabry-Perot) and/or a liquid crystal element. Furthermore, these layers can also comprise combinations of the above-named examples and thus in particular provide several security features in the background area.

The reflective layer 14 is not provided in the background area 20 and is provided in the pattern area in first zones 31, but not in second zones 32. The first zones 31 here are spaced apart from each other by less than 300 μm, preferably spaced apart from each other by between 25 and 250 μm and have a minimum dimension of less than 300 μm, preferably of between 5 and 100 μm. By minimum dimension is meant here the width of the first zones 31, i.e. the smallest distance between two boundary points of the zone which lie on a common straight line running through the centroid of the zone.

Furthermore, it is also possible for the reflective layer 14 to be provided in inverse form in the pattern area and thus provided in one or more first zones 31 and not provided in one or more second zones 32. The first zones 31 here are, as already described above, spaced apart from each other by less than 300 μm, preferably spaced apart from each other by between 25 and 250 μm and reference is made in this regard to the above statements.

The area size of the first zones and their spacing are preferably chosen such that the proportion of the surface of the pattern area 21 covered by the first zones and/or the proportion of the surface of the respective design element 22 covered by the respective first zones is between 1 and 80%, in particular between 5 and 50%, for example 15%.

Thus, for example in the respective design elements 22, the reflective layer 14—as shown in FIG. 1a—is divided into dot-shaped or rectangular first zones 31 in which the reflective layer 14 is provided, and which are surrounded by a second zone 32 in which the reflective layer 14 is not provided. The reflective layer 14 is not provided in the background area 20 surrounding the design element 22.

Furthermore, it is also possible for the reflective layer 13—as shown in FIG. 1b—not to be provided in the respective design element 22 in dot-shaped or rectangular first zones 31 which are surrounded by a second zone 32 in which the reflective layer 14 is provided. The reflective layer is not provided in the background area 20 surrounding the design element 22.

In addition, it is also possible for some of the design elements 22 to be designed according to the arrangement shown in FIG. 1a and some of the design elements 22 of the security element 1 to be designed in the arrangement shown in FIG. 1b. It is thus also possible for the security element 1 firstly to have one or more design elements 22, in the pattern area 21 of which the reflective layer 14 is provided in the first zones 31, but not in the one or more second zones 32, and for one or more design elements 22 to be provided, in the pattern area 21 of which the reflective layer 14 is provided in one or more second zones 32, but not in the first zones 31.

Through such a design of the reflective layer 14 it is achieved that the design element 32 is still sufficiently transparent, in order that optically perceptible information provided beneath the design element 32 is visible through the substantially opaque reflective layer 14, but in addition that this information is then superimposed by an item of information visible in reflection which is determined by the formation of the pattern area 21 and of the surface relief 18.

As represented in FIG. 2, the surface relief 18 here is preferably aligned registration-accurate, i.e. positionally accurate, relative to the first zones 31. The reflective layer 14 and the surface relief 18 are thus formed by means of processes registered relative to each other. Registered processes mean that the relative positions of the, in particular patterned, reflective layer 14 and of the, in particular patterned, surface relief 18 relative to each other are aligned positionally accurate relative to each other during the individual process steps for example by means in particular of optically detectable register marks. Preferably, it is hereby achieved that in the background area 20 and/or in the one or more second zones 32 the surface relief 18 is not moulded or a surface relief is provided there which differs from the surface relief 18 moulded in the zones 31, in particular its aspect ratio differs from the surface relief 18 by at least 50%.

It is thus of particular advantage if the relief structures determining the optically variable appearance of the pattern area 22 are only moulded in the zones 31 of the replication layer 15 and the formation and arrangement of the zones 31 takes place depending on the surface relief 18 to be provided for the corresponding optically variable effect in particular during the production of the security element 1.

To produce the security element 1, the detachment layer or adhesion promoter layer 16 is thus for example first applied to the whole surface of the carrier layer 17 for example by means of printing, then the replication layer 15 is applied to the whole surface for example by means of printing and then the surface relief 18, as already stated above, is moulded into the replication layer 15 in the area of the first zones 31. Then the reflective layer 14 is preferably applied or structured registered relative to this, i.e. positionally accurate relative to this. For this, it is possible for example for the reflective layer 14 to be applied to the whole surface, for example by vapour deposition or sputter deposition, and then to be removed again by means of positive or negative etching, by means of a washing process, by means of mechanical ablation or by means of laser ablation in the area of the second zones 32 and in the background area 20. Furthermore, it is also possible—for example by means of an evaporation mask—for the reflective layer 14 to be applied only in the area of the first zones 31. Reflective layers can, however, also be applied locally by means of a printing process. The material of the reflective layer is dispersed for example in the printing lacquer or the reflective layer forms in a chemical or physical reaction during and/or after the printing and the locally applied print serves only to fix the opaque areas, for example by local deposition. Furthermore, it is also possible, in order to register these processes, i.e. in order to achieve the positional accuracy of the processes, for different relief structures the properties of which are then used in particular for the structuring of the reflective layer 14 registration-accurate, i.e. positionally accurate, to be moulded into the first zones 31 on the one hand and into the second zones 32 and in the background area 20 on the other hand.

A structure is represented in FIG. 2 in which the replication layer 15 lies between the reflective layer 14 and the observer. However, the sequence of layers can also be reversed, i.e. the reflective layer 14 can lie between replication layer 15 and observer. In many designs, the opaque reflective layer 14 is thin enough and thereby follows the surface relief sufficiently precisely to ensure that the surface relief has an optical effect when viewed from both sides.

If—as set out above—a multi-layered sequence of one or more transparent or translucent dielectric reflective layers and an opaque layer is used as reflective layer 14, it is also possible for the dielectric reflective layer to be provided over the whole surface in the security element and only a structuring or a structured application of the opaque layer takes place, with the result that the reflective layer 14 forms in each case an opaque reflective layer in the area of the first zones 31 and forms in each case a transparent or translucent reflective layer in the second zones 32. A further advantageous variant is that an opaque metallic reflective layer is provided in the zones 31 and that a largely transparent HRI layer is present partially or over the whole surface in the background area 20 as a further reflective layer.

The surface relief 18 is preferably composed of one or more relief structures which are selected from the group: diffractive grating, hologram, blazed grating, linear grating, cross grating, hexagonal grating, asymmetrical or symmetrical grating structure, retroreflective structure, refractive or diffractive microlens, refractive or diffractive microprism, zero-order diffraction structure, moth-eye structure or anisotropic or isotropic matte structure or a superimposition of two or more of the above-named relief structures. Thus it is possible for example for different relief structures to be provided in different areas of the first zones 31 or for different relief structures to be provided in different first zones 31 or for different relief structures to be provided in different design elements 22. It is hereby possible for different design elements to display a different optically variable appearance, for different areas of the pattern area 21 or different areas of a design element 22 to display different colours or a different brightness or for optically variable effects to be able to be generated hereby which cannot be imitated for example by means of a holographic surface relief.

The security element 1 is viewed according to the viewing direction 10.

During the production of the security element 1, the decoration layer 12 is applied for example to the substrate layer 11 by means of a printing process and then the transfer film 110 is applied to the surface of the substrate layer 11 imprinted with the decoration layer 12. Furthermore, it is also possible for the decoration layer 12 to be printed onto the adhesive layer 13 or onto the replication layer 15. Furthermore, it is also possible for the personalized items of information 23 and 24 to be inscribed by means of a laser into the decoration layer 12 after completion of the security element 1 or during the production of the security element 1, wherein the laser here is preferably arranged on the side of the reflective layer 14 opposite the decoration layer 12.

FIG. 3 shows a cut section of a security element 2. The security element 2 here has a background area 20 and a pattern area 21 which is formed by several linear design elements 20, of which two design elements 22 are represented by way of example in sections in FIG. 3. The layer structure of the security element 2 corresponds to the layer structure of the security element 1 and reference is made, regarding this, to the previous statements regarding the security element 1.

The security element 2 furthermore has an item of optical information 25 which is provided by the decoration layer 12 arranged beneath the reflective layer 14 and which, as shown in FIG. 3, is superimposed on the background area 20 and also on the pattern area 21 in areas.

In the security element 2—as already set out above—the pattern area 21 has two or more design elements 22 which are shaped in the form of lines. By line is meant here a design element the width of which is at least 10 times greater than its length. The width of the lines is preferably between 5 and 250 μm, for example the width of the lines is 50 μm. As indicated in FIG. 3, the linear design elements 22 have first zones 31 and second zones 32 which are arranged according to a one-dimensional grid along the longitudinal direction of the respective lines. Thus, in each case only one first zone 31 is provided over the width of the respective line. In the embodiment example according to FIG. 3, the respective first zone 31 here occupies the whole width of the lines, thus the width of the first zones 31 corresponds to the width of the respective line. As represented in FIG. 3, the width of the respective first zones 31 here is constant and is for example between 5 and 250 μm, further preferably between 10 and 100 μm. The spacing between them varies, whereby the brightness of these design elements along the line varies for the human observer. The first zones 31 here, as described above or also later with reference to FIG. 4a, FIG. 4c or FIG. 6a to FIG. 7, are overlaid with surface structures of the surface relief 18. However, it is also possible to dispense with a moulding of the surface relief 18 in the first zones 31.

FIG. 4a shows, by way of example, a cut section of a security element 3 which is constructed according to the security element 2 and the security element 1. In respect of the structure of the security element 3 reference is thus made to the previous statements about FIG. 1 to FIG. 3. As represented in FIG. 4a, the pattern area 21 here likewise has linear design elements 22, of which three design elements 221, 222, 223 are shown by way of example in FIG. 4a. The design elements 221 to 223 in each case have a sequence of first zones 31 and second zones 32 as shown in FIG. 4a. The first zones 31 of the design elements 221, 222, 223 here are overlaid with respectively different relief structures, as indicated in FIG. 4a by the different shading of these zones.

The division of the design elements 221 to 223 into first zones and second zones here is adapted individually for each of the design elements 221 to 223, with the result that no disruptive effects, such as for example a Moiré pattern or a larger interruption, occur. The spaces between the first zones 31 are chosen such that with the naked eye an observer recognizes three continuous lines. For example, the spaces between the first zones 31 are less than 300 μm.

The spaces between the zones 31, their shape and their size can vary along the line. Criteria for the design of the first zones are for example avoiding disruptive collisions with further adjacent design elements 22 or avoiding Moiré interference effects with optical information lying underneath, for example with optical information provided by the decoration layer 12.

If linear design elements 22 are used, it is particularly preferable here to design the arrangement and formation of the first zones as well as their overlaying with relief structures of the surface relief 18 as below with reference to FIG. 4b to FIG. 4c. Such design elements can here be used for example in the security element according to FIG. 1 or in the security elements 2 and 3 according to FIG. 3 or FIG. 4.

FIG. 4b shows three different possibilities for designing a linear design element 22. For this, FIG. 4b shows three linear design elements 224, 225 and 226. The design elements 224 to 226 are in each case formed as a line, as has been explained by way of example above for the design elements 22 of the security element 2.

The design element 224 has a sequence of first zones 31 which are separated by a respective second zone 32. Here the size of the first zones 31 varies along the line in order to produce a local different intensity in particular of an optically variable effect. As shown in FIG. 4b, the extent of the first zones 31 in the direction of the width of the line is varied here, while the extent of the first zones 31 in the longitudinal direction of the line and/or the spacing between the first zones 31 along the line is constant. Studies have shown that the brightness of the design element can hereby be varied along the line, but without distorting the brightness of information lying underneath in the area along the line.

In the design element 225 the area size of the first zones 31 along the line is chosen constant. The first zones 31 here are divided into two part-zones 33 and 34, wherein here only the part-zones 34 are overlaid with relief structures of the surface relief 18 and the part-zones 33 are not overlaid with a surface relief or form a mirror surface. As represented in FIG. 4b, the area size of the part-zones 33 and 34 varies along the line here, while the area size of the zones 31 remains constant. Thus, the average transmission of the design element 225 along the line remains constant, but the brightness in different viewing directions and/or the colour of the design element 225 varies along the line. Furthermore, it is also possible here for the first zones 31 to be divided into more than two part-zones which are overlaid with different relief structures, as will also be explained later by way of example with reference to FIG. 4c, FIG. 6a and FIG. 7.

The design element 226 thus also has first zones 31 which are divided into two part-zones 34 and 35 which are overlaid with different relief structures.

The targeted variation of the local area density, i.e. the surface area of the first zones 31 and their spacing as well as the overlaying of the first zones 31 with relief structures, can be used to represent additional information. Thus, an observer can recognize in the mirror reflex for example an item of macroscopic image information or a text, without the representation in the diffractive optical feature being influenced by it. This additional information can also consist of a polarization feature which only becomes recognizable when viewed through a suitable filter.

In addition, the spaces between and the area size of the first zones 31 can be suitably varied, with the result that an observer recognizes a first diffractive feature and a Moiré pattern independent thereof becomes visible when viewed through a suitable filter. As already mentioned above, for example by varying the area size and/or spacing a concealed item of information can be encoded here by the corresponding arrangement of opaque surfaces or lenses of a Moiré verification element, which item of information only becomes visible when superimposed with the Moiré verification element.

In addition, [onto] the arrangement of the first zones 31 relative to each other and/or the arrangement of relief structures inside the respective first zone can be used to encode further information.

By way of example, FIG. 4c shows several further possibilities for dividing first zones 31 into part-zones which are overlaid with different relief structures. FIG. 4c thus shows a first zone 311 which is divided into part-zones 34 and 35, a first zone 312 which is divided into part-zones 34 and 35 and a part-zone 313 which is divided into part-zones 34, 35 and 36. The part-zones 34, 35 and 36 are in each case overlaid with different relief structures. Here, for example, the part-zone 34 is underlaid with a diffraction grating which generates a dynamically coloured Kinegram® and the part-zones 35 are overlaid with an anisotropically scattering matte structure. Thus, for example, from one viewing direction a design element provided with first zones 311 can display a dynamically coloured Kinegram®, while from another viewing direction a static achromatic feature with identical graphic content is recognizable. In the first zone 313 three part-zones are provided which for example, likewise from different viewing directions, display a different optical feature, or also are overlaid with grating structures which display a different colour and thus make it possible to form a true-colour image in the pattern area 21, wherein the relative proportion of the surface covered by the part-zones 34, 35 and 36 determines the tone and the area size of the first zone 313 [and] the respective local brightness (intensity).

The design and the arrangement of the first zone 31, as explained above with reference to FIG. 4a-FIG. 4c, thus make it possible to form linear design elements 22 which convey a different optical impression along the line in different viewing directions and/or have a locally different colour and/or a locally different brightness and/or transparency. The use of linear design elements which, as set out above, have first zones 31 arranged along the line makes possible a contour-sharp representation of fine lines in the pattern area which can only be imitated inadequately with a regular grid in a reflective layer and an overlaying, not registered relative to this, i.e. not positionally accurate, with relief structures provided in linear areas. Thus, a security element is provided which can only be imitated and manipulated with difficulty.

A further possibility for the arrangement of first zones 31 in a design element 31 and for the corresponding arrangement of relief structures of the surface relief 18 relative to this is explained by way of example below with reference to FIG. 5a and FIG. 5b.

FIG. 5a and FIG. 5b illustrate firstly the formation of the surface relief moulded into the replication layer 18 or the structuring of the reflective layer 14 in a partial section of a design element 227.

As indicated in FIG. 5b, first zones 31 are provided here which are overlaid with the opaque reflective layer 14 and which are surrounded by a second zone 32. Registered, i.e. positionally accurate, relative to this, as shown in FIG. 5a, microlenses 181 are moulded in the replication layer 18 in the first zones 31. These microlenses can be shaped as refractive lenses or as diffractive lenses. As shown in FIG. 5a and FIG. 5b, the structuring of the metal layer 14 takes place here precisely registered, i.e. positionally accurate, relative to the lenses 181, with the result that each lens 181 is completely overlaid with the reflective layer 14, but the surrounding areas are completely transparent or translucent. The adaptation of the first zones to the shape of the lenses 181 and the registered, i.e. positionally accurate, arrangement of the lenses 181 relative to the reflective layer 14 make it possible to increase the transparency of the design element 227 compared with an unregistered, i.e. not positionally accurate, arrangement or to improve the contrast of the security feature.

FIG. 6a and FIG. 6b illustrate a further possibility for the shaping and arrangement of first zones 31 and relief structure of the surface relief 18 relative to each other. For this, FIG. 6a illustrates the arrangement of relief structures moulded into the replication layer 18 and FIG. 6b illustrates the arrangement and shaping of the first zones in the reflective layer 14 in a partial section of a design element 228.

The zones 31 here are arranged in the form of a regular two-dimensional grid and shaped in the form of rectangles. It is also possible for the grid here to be irregular and in particular also to be adapted to the contour of the design element 228. The zones 31 can in addition also have another shape or also vary in their area size, as has already been described above in relation to linear design elements.

Each of the first zones 31 here is divided into four part-zones, namely the part-zones 34, 35, 36 and 37, which—as already stated above—can have different relief structures. The filling of the part-zones 34 with a relief structure 182 is shown by way of example in FIG. 6a.

The relief structures in the part-zones 34 to 37 serve for example to represent four different contents which are visible for example in different viewing directions. The part-zones here can have for example diffractive relief structures, for example diffractive gratings, refractive relief structures or also scattering relief structures or also mirror surfaces. Thus, for example, each zone 31, as shown in FIG. 6a, is divided into four part-zones, wherein each of the part-zones is in each case allocated to a viewing direction and the overlaying of the respective part-zones for example corresponds to the brightness information of the image recognizable in the allocated viewing direction.

As already stated above, the first zones 31 in this embodiment example are preferably spaced apart from each other by between 25 and 250 μm and the dimensions of the first zones 31 preferably lie in the range of between 5 and 100 μm. The fill factor, i.e. the overlaying of the design element 228 with first zones 31, here is preferably approximately 15%, with the result that 85% of the surface remains transparent.

FIG. 7 shows a cut section of a design element 229. The design element 229 has first zones 31 which are separated from each other by a second zone 32. As indicated in FIG. 7, the area size of the first zones 31 varies locally, with the result that here—as already set out above for linear design elements—the local total intensity or brightness of the pattern area is varied. Furthermore, the first zones 31 are divided into part-zones 34, 35 and 36. In the part-zones 34, 35 and 36 different relief structures are provided, for example diffraction gratings, which have a different spatial frequency [differently] or a different azimuthal angle. As indicated in FIG. 7, in addition to the area size of the zones 31 the area size of the zones 34, 35 and 36 relative to each other thus also varies. If for example relief structures which convey a different colour impression are thus moulded into the part-zones 34, 35 and 36 as relief structures, the colour produced as a whole can be set by the proportion of the surface covered by the part-zones 34 to 36 relative to each other and the brightness or intensity can be set by the area size of the zones 31. These measures make it possible to vary the colour and the brightness locally in a design element and thus to provide for example a true-colour image which, as first item of information, superimposes an individualized second item of information.

FIG. 8 shows a schematic representation of a design element 230 of the pattern area 21 which has linear first zones 31 which are separated from each other by second zones 32. In addition, the design element 230 is surrounded by the background area 20.

As represented in FIG. 8, the first zones 31 are shaped as parallel lines which follow the external and internal contour of the design element 230. The width of these lines is preferably between 5 and 250 μm, further preferably between 10 and 100 μm. The design element 230 is preferably a design element the width and/or height of which is greater than 1 mm, preferably greater than 2 mm. The design element 230 is shaped as a letter by way of example as shown in FIG. 8. However, the design element 230 can also have another shape, for example be shaped in the form of another letter or a number, or also display a figurative representation, an emblem or a pictogram. It is also possible here for the design element either to have one or more lines which follow the internal and/or external contour or also to have further lines which are not arranged parallel to the internal and/or external contour and which make possible for example an adaptation to an internal contour differing from the external contour. In addition, it is also possible for the linear first zones 31 to have a different width and to produce a visually recognizable figurative representation for example because of a width modulation of the linear first zones 31, or for the linear first zones 31 to be interrupted in areas regularly, irregularly or stochastically and in each case not to form a closed line as represented in FIG. 8a. However, the layout of the lines can also be generated completely independently of the external shape of the design element 230 and consist for example of parallel or concentric lines. Average surface coverings in the range of from 5 to 40% are particularly advantageous, as they allow both a sufficient reflection and a high transmission. Furthermore, spaces between the lines in the range of 10-200 μm are advantageous.

Instead of lines, the design element 230 can also have a reflective layer in the form of fine text or figurative representations, symbols, letters, numbers or logos. The details reveal themselves to an observer only on inspection with a tool, such as for example a magnifying glass or a microscope. The local brightness distribution recognizable by the observer with the naked eye can be influenced for example by the size of the text, the font (typeface), the spacing of the letters or the overlaying with microstructures. Here too, it is particularly advantageous if—as set out above—the surface relief 18 is provided registration-accurate relative to the zones 31. Furthermore, the surface relief here can in addition also have along the linear first zones 31 part-zones which are overlaid with different relief structures in order to thus generate the effects already explained above.

The security element 1 can in addition also have a pattern area 21 which has different design elements 22. Thus, for example, one or more linear design elements which are formed according to FIG. 3 to FIG. 4c, one or more design elements which are formed according to the design element 227, one or more design elements which are formed like the design elements 228 or 229, and/or one or more design elements which are formed like the design element 230 can be combined with each other. Through such combinations of different design elements, a security element can be provided which is characterized by a particularly high protection against forgery.

1. A security element, with a pattern area, comprising one or more design elements, the shape of which provides a first optically perceptible item of information, and a background area surrounding the one or more design elements of the pattern area at least in areas, wherein the security element has an opaque reflective layer which is not provided in the background area, and in the pattern area is provided in first zones, but not in one or more second zones or is provided in one or more second zones, but not in first zones, wherein the first zones are spaced apart from each other by less than 300 μm and have a minimum dimension of less than 300 μm.

2. A security element according to claim 1,
wherein the proportion of the surface of the pattern area covered by the first zones is between 2 and 50%.

3. A security element according to claim 1, wherein
all layers of the security element arranged above the opaque reflective layer relative to the viewing direction of the security element are, at least in areas, transparent or translucent and/or diaphanously dyed.

4. A security element according to claim 1, wherein
the security element for generating a second optically perceptible item of information which is superimposed on both the pattern area and the background area at least in areas, and wherein the decoration layer is arranged beneath the opaque reflective layer relative to viewing direction of the security element, and wherein all layers of the security element arranged between the opaque reflective layer and the decoration layer are transparent or translucent.

5. A security element according to claim 1, wherein
all layers of the security element arranged beneath the opaque reflective layer relative to the viewing direction of the security element are transparent or translucent at least in areas.

6. A security element according to claim 1, wherein
the security element in which in the first zones at least in areas an optically active surface relief for generating an optically variable effect, is moulded.

7. A security element according to claim 6, wherein
the surface relief comprises one or more relief structures selected from the group: diffractive grating, hologram, blazed grating, linear grating, cross grating, hexagonal grating, asymmetrical or symmetrical grating structure, retroreflective structure, microlens, microprism, zero-order diffraction structure, moth-eye structure or anisotropic or isotropic matte structure, or a superimposition of two or more of the above-named relief structures.

8. A security element according to claim 6, wherein in that in the second zones and/or in the background area no surface relief is moulded in the replication lacquer layer or a surface relief the aspect ratio of which differs from the surface relief moulded in the first zones by at least 50% is moulded.

9. A security element according to claim 6, wherein,
the surface relief is moulded in the boundary surface between replication layer and opaque reflective layer.

10. A security element according to claim 6, wherein,
in a large number of first zones in each case a microlens or a microprism is moulded into the replication layer as surface relief, wherein the respective microlens or the respective microprism occupies the whole surface of the respective first zone.

11. A security element according to claim 6, wherein
the proportion of the surface covered by the respective first zones which is overlaid with the surface relief varies locally in the pattern area.

12. A security element according to claim 6, wherein
each of the first zones is divided into n part-zones in which different relief structures are moulded into the replication layer as surface relief, wherein n>2.

13. A security element according to claim 12, wherein
each of the part-zones of each first zone is allocated to one of m viewing directions, wherein the area size of the respective part-zones is varied locally to determine the local brightness in the viewing direction allocated to the respective part-zone.

14. A security element according to claim 12, wherein
each of the part-zones of each first zone in each case is allocated to one of k colour components, wherein the area size of the respective part-zone is varied locally to determine the local brightness and the colour value.

15. A security element according to claim 1, wherein
the first item of optical information has a brightness that is locally different in reflection, which is determined by the respective local area size of the first zones and/or is superimposed with an optically variable item of information which is determined by the type of and respective proportion of surface covered by the relief structures of the surface relief moulded in the first zones.

16. A security element according to claim 1, wherein
the width, length and/or spacing of the first zones is varied to generate a concealed item of Moire information which becomes visible as a third item of information when superimposed with an allocated Moire verification element, wherein the first zones form a 1-d or 2-d Moire.

17. A security element according to claim 1, wherein
the pattern area is shaped in the form of a macroscopically visible design and at every point has a width and/or a length of more than 1 mm.

18. A security element according to claim 1, wherein
the first zones in the pattern area are arranged according to a one- or two-dimensional grid, wherein the grid width is between 5 and 1000

19. A security element according to claim 1, wherein
the spaces between the first zones are between 25 and 250 μm and/or wherein the width and/or length of the first zones is between 5 and 200 μm.

20. A security element according to claim 1, wherein
the pattern area comprises one or more design elements which in each case are shaped in the form of a line the width of which is at least 10 times greater than its length, and is shaped in the form of a guilloche.

21. A security element according to claim 20, wherein
the width of the line is between 5 and 250.

22. A security element according to claim 20, wherein
different relief structures are moulded as surface relief in the first zones allocated to different lines.

23. A security element according to claim 20, wherein
the spaces between the first zones vary along the respective line.

24. A security element according to claim 20, wherein
the first zones are arranged according to a one-dimensional grid along the longitudinal direction of the respective line, with the result that in each case only one first zone is provided over the width of the line.

25. A security element according to claim 20, wherein the extent of the first zones varies in the direction of the width of the line, wherein the extent of the first zones in the longitudinal direction of the line and/or the spacing of the first zone is constant.

26. A security element according to claim 20, wherein,
the area size of the first zones varies along the respective line in order to produce locally different brightnesses or intensities in reflection.

27. A security element according to claim 1, wherein the pattern area comprises one or more design elements in the area of which first zones are shaped as one or more, parallel, lines which follow the external contour and/or internal contour of the respective design element.

28. A security element according to claim 1, wherein
the opaque reflective layer consists of metal, of a combination of a transparent reflective layer with metal or of one or more transparent reflective layers and an opaque lacquer layer.

29. A security element according to claim 1, wherein
the opaque reflective layer consists of an electrically conductive material or comprises such a material and provides a fourth electrically readable item of information through the formation of the first zones as RF elements or through the influencing of the surface conductivity by the spacing of the first zones.

30. A security element according to claim 1, wherein
the opaque reflective layer has a galvanic reinforcement layer with a layer thickness of between 0.2 and 20 μm.

31. A process for producing a security element, comprising the steps of:
providing a transparent transfer film with an area which is divided into a pattern area, the shape of which provides a first item of information, and into a background area surrounding the pattern area at least in areas,
forming an opaque reflective layer which is not provided in the background area, and in the pattern area is provided in first zones, but not in one or more second zones, or in the pattern area is provided in one or more second zones, but not in first zones, wherein the first zones are spaced apart from each other by less than 300 μm and have a minimum dimension of less than 300 μm, applying the transfer film to a substrate such that a personalized decoration layer which provides a second item of information is arranged between the transfer film and the substrate.

32. A process for producing a security element, in particular value document, comprising the steps of:
providing a security element according to claim 1,
inscribing by means of a laser a personalized item of information into a laser-sensitive decoration layer arranged beneath the opaque reflective layer, wherein during the inscription the opaque reflective layer is arranged between the laser and the decoration layer.

33. A process according to claim 32, wherein
the laser is controlled such that areas with opaque reflective layer are omitted when the personalized information is inscribed or at least are impacted with reduced power.
